(19) United States
(12) Patent Application Publication
(10) Pub. No.: US 2002/0087478 A1
(43) Pub. Date: Jul. 4, 2002

(54) Wireless financial transactions

(76) Inventors: Neil P. Hudd, Marblehead, MA (US); Orin Anderson, Augusta, ME (US)

Correspondence Address: DAVID L. FEIGENBAUM, Fish & Richardson P.C., 225 Franklin Street, Boston, MA, 02110-2804, US

(21) Appl. No.: 09/753,507

(22) Filed: Jan. 3, 2001

(51) Int. Cl. G06F 17/60; H04K 1/00; H04L 9/00

(52) U.S. Cl. 705/64; 705/39

(57) ABSTRACT

Simultaneous communication sessions between electronic devices and a server are carried on communication links each of which is at least partially wireless. Information is sent from the devices to the server information associated with proposed debit or credit transactions. The transactions are completed using an application running on the server. The communication sessions are maintained in existence during inactive periods when information about another debit or credit transaction is not waiting to be sent from one or more of the devices to the server. After the inactive periods, the maintained communication sessions are used to send, from the devices to the server, information associated with other proposed debit or credit transactions.

### BACKGROUND

This invention relates to wireless financial transactions.

Buying dinner at a restaurant, for example, typically involves presenting a credit card, debit card, or smart card. The card is removed from the direct site of the diner to a local transaction machine where it is “swiped” by the waiter. The local machine transmits the card number and other information to a central service and receives back an authorization number for the transaction. The bill is printed, and the patron signs it.

The local machine is often located at the cash register of the restaurant, and the local machine is connected to the central service by an automatically dialed telephone call. The machine can also be a handheld device carried to the table where the patron has had his meal. The card is swiped on the handheld device, which communicates wirelessly through a local network that makes the connection to (or in some cases, directly to) the central service. When the bill has been authorized, a printer in the handheld device prints a check to be signed by the patron, and a second copy is given to the patron as a receipt.

When a transaction is authorized and the bill has been signed, the local machine records the amount of the transaction as part of the accounting system of the restaurant. To collect the funds represented by the checks signed by card holders, the restaurant presents the information either electronically or on paper to the card issuers for payment. The restaurant's accounting system balances the payments received from the card issuers against the accounting entries that had been made at the time of purchase. As an incentive to the restaurant to obtain the authorization and signature, the restaurant is charged lower fees on the resulting transactions.

To complete the transactions in this way, the restaurant's accounting computer, local machine, and/or handheld devices typically run custom software. The software is sometimes updated to provide new features and to accommodate new equipment that is put into service. Credit card numbers and transaction information are stored on the restaurant's equipment to enable the transactions to be completed. The presence of the information on the restaurant's equipment provides opportunities for security breaches and fraud.

Naturally, this scenario is not limited to restaurants but extends to every kind of entity that engages in transactions that are based on presentation of financial account information and that must be executed through consultation with a central service.

Because of the large number of different kinds of machines, computers, and hand-held devices, each card issuer and each bank that deals with parties who accept cards or similar tokens must create, maintain, and frequently update complex software that can receive the authorization requests, return the authorizations, receive the bills for payment, and credit the accounts for all of the different kinds of platforms operated by the parties with which it deals.

### SUMMARY

Implementations of the invention may include one or more of the following features. The electronic devices may be off-the-shelf stand-alone hand-held devices. At least one of the communication links may use a TCP/IP protocol. The information about the debit or credit transactions may be entered interactively through user interfaces of the devices. The information about the transactions may be discarded at each of the devices when the transactions have been completed.

In general, in another aspect, the invention features the combination of (a) electronic devices configured to be capable of initiating and maintaining communication sessions with a server, the communication sessions being carried on communication paths that are at least partially wireless, and (b) a server configured to receive information sent from the devices, using the communication sessions, about debit and credit transactions, and to maintain the sessions at times when no information about debit and credit transactions is being sent from the devices to the server.

In general, in another aspect of the invention, the information being about a proposed credit or debit transaction information is exchanged with a user at the electronic device, the information being exchanged through a user interface that includes an information display and an information input device. The display of information to the user on the information display and the receipt of information from the user through the information input device is controlled through the communication link by an application running on the server.

In general, in another aspect of the invention, the information about the transactions includes confidential identification information, which is discarded discarding after the transactions have been effected so that the confidential identification information is not retained on the electronic device when it is powered down.

In general, in another aspect of the invention, an application running on the server is configured to effect credit and debit transactions using the received information received from the hand-held devices. The application is updated on the server without updating any application related to the processing of credit and debit transactions on the devices. After the updating, credit and debit transactions continue to be effected using the updated application.

In general, in another aspect of the invention, other applications are run at the server, the other applications not being ones that effect credit or debit transactions. User interfaces at the hand-held devices are controlled from the server to provide functions of the other applications to users of the hand-held devices at times when information about credit or debit transactions is not being exchanged.

In general, in another aspect, the invention features the combination of (a) an interactive handheld device, (b) a reader for reading debit or credit cards to be used in debit or credit transactions entered on the hand-held device, and (c) a printer adapted to print receipts for debit or credit transactions. The device, the reader, and the printer have short-range wireless communication capability to carry information about the credit or debit transactions between the device and the reader and between the device and the printer.

Among the advantages of the invention are one or more of the following. Anyone who engages in financial transactions with others based on credit, debit, or smart cards (or other information identifying a financial account) can complete the transactions quickly, simply, and wirelessly, using only a small local device. The local device need not store card numbers or transaction data and need not run accounting or other special software to track the transactions. All of the accounting functions and details can be maintained centrally by the merchant's bank and/or the card issuer. Additional services may be easily provided from the central location. The card issuer and the merchant's bank need not create and maintain multiple application modules to accommodate a wide variety of merchant platforms.

Other advantages and features will become apparent from the following description and from the claims.

### DESCRIPTION

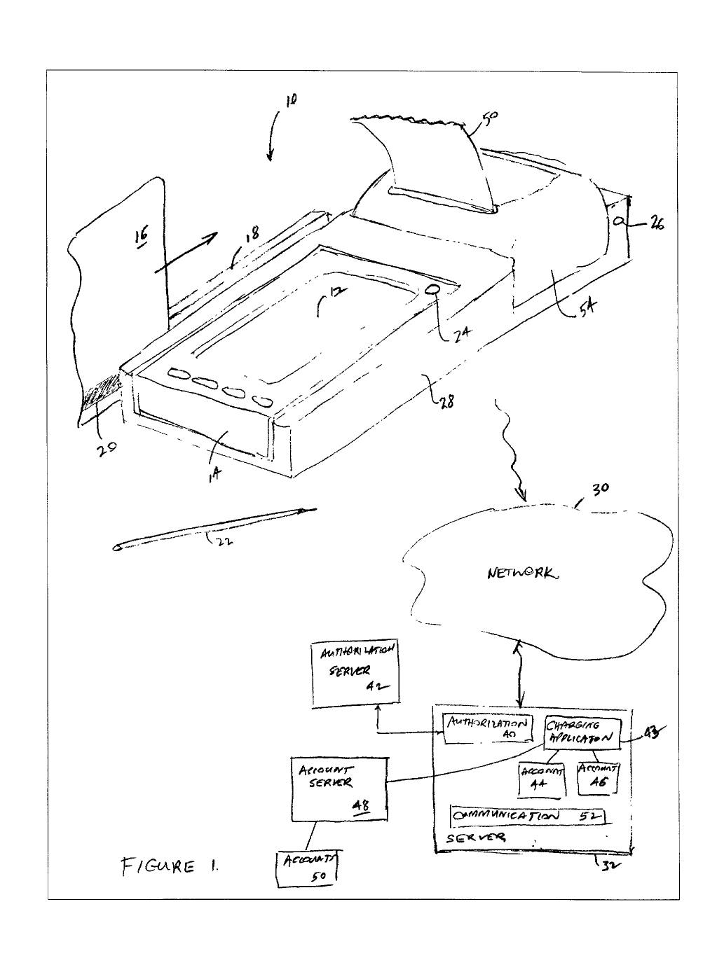

FIG. 1 is a perspective view of a hand-held device and a block diagram of a server.

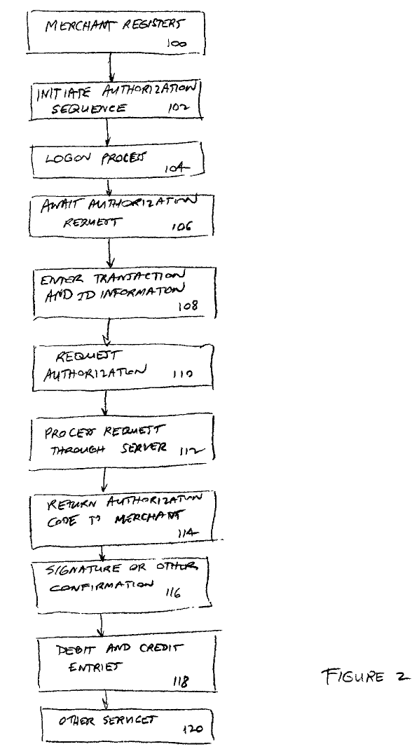

FIG. 2 is a flow chart.

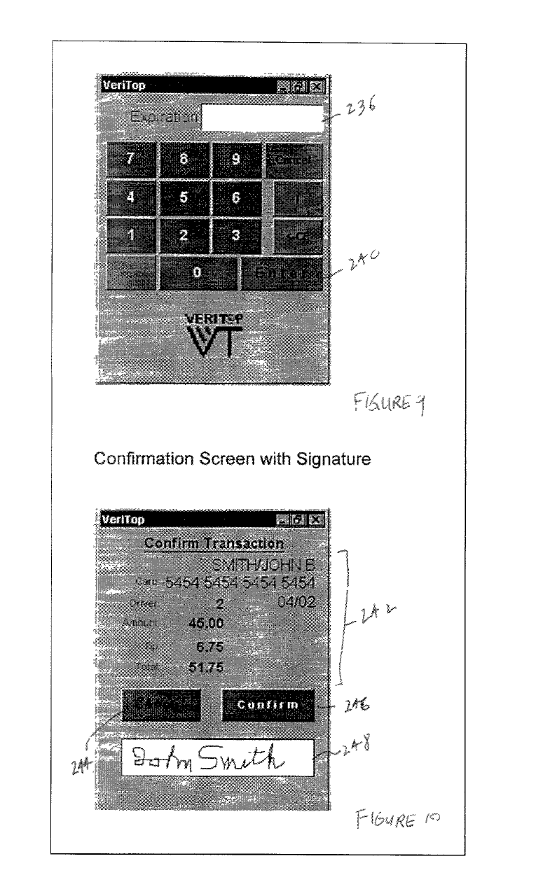

FIGS. 3 through 11 show screen displays.

In the example implementation shown in FIGS. 1 and 2, before a credit or debit card purchase is initiated, a merchant of products or services, e.g., a limousine driver in the specific example described here opens a communication session between a hand-held standalone, off-the-shelf device (such as a PDA using the PalmOS or WindowsCE) and a server 32.

The communication session is maintained in existence continually until terminated, e.g., by the user shutting down the PDA. The user may effect a credit or debit transaction, be inactive for a possibly long period of time, and then effect another debit or credit transaction. The communication session remains in existence even during the inactive periods so that there is no delay and no reinitiation process required at the time of the later transaction. A large number of other electronic devices may also maintain simultaneous communication sessions through other communication links with a mainframe server 32 using client/server software described later. Each of the communication links may be at least partially wireless.

When the driver wishes to open a communication session, he uses the login screen shown in FIG. 3, which is displayed on the screen of his PDA. The logon screen enables the driver to register 100 with an authorization service provided through an extensive network maintained by a mainframe server 32. The registration can be done on-line through a web-site provided by the server or, alternatively, by telephone or mail. The registration identifies the merchant and his commercial account in a manner similar to conventional registration with any card authorization service.

Once the driver has registered at the beginning of a day, he may use the authorization service at any time during the day with respect to any number of customers.

To initiate an authorization sequence for a particular debit or credit transaction for a given customer, the merchant indicates to the hand-held device a desire to initiate the sequence (102). An authorization server 40, running on the server 32, then controls the sequence and communicates user interface information back and forth with the hand-held device in a manner described later. The communication in one example is done through a cellular digital packet data (CDPD) network to a server operated by, say, Visa.

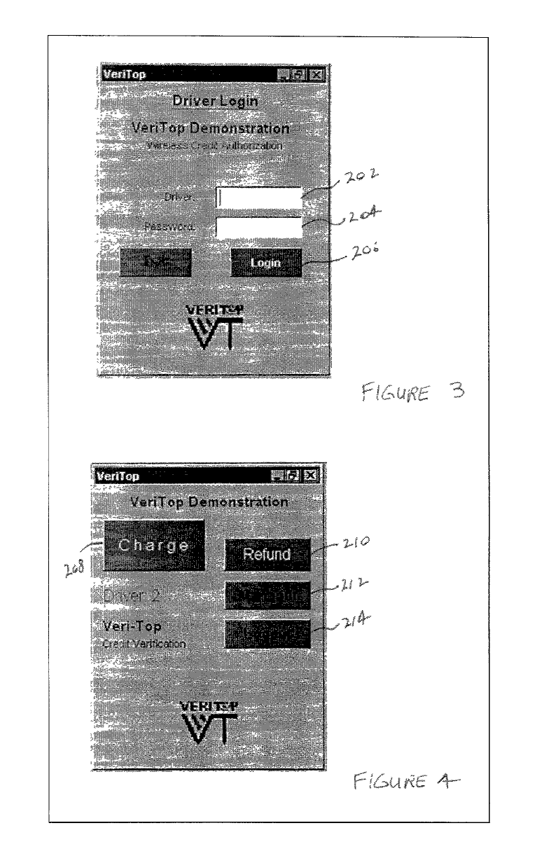

As shown also in FIG. 3, the server requests identification 202 and security code (password) 204 information from the driver as part of a log-on (registration) process 104. The login button 206 is clicked. Once the information is verified, the authorization application causes the hand-held device to display a screen (FIG. 4) or otherwise indicate that it is awaiting a specific authorization request (106).

The screen shown in FIG. 4 includes a charge button 208 by which the user indicates that he wants to process a charge transaction and a refund button 210 by which the user indicates that he wants to process a refund transaction. Refund transactions are handled using the same screens that initiate the charge, except that the transaction is now reversed exactly as it was entered, and the credits are applied accordingly. A logout button 212 enables the user to terminate his session. A manager button 214 provides an override function that enables a manager to print reports or approve refunds as is the normal procedure for accounts processing.

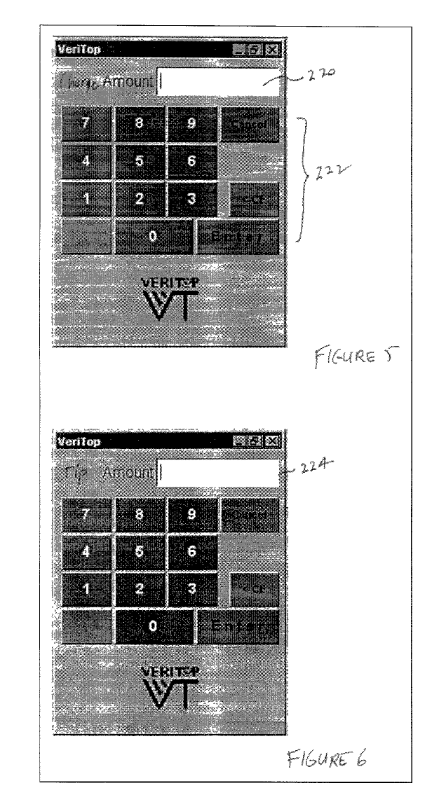

As shown in FIG. 5, the authorization request begins by the card holder or driver indicating (108), through the interface provided by the hand-held device, information about the transaction, such as a dollar amount 220 and an item description (not shown in this example), on a touch surface 12 of a personal digital assistant (PDA) 14 (such as a Palm™ Pilot). The amount is entered using a displayed numeric keypad 222. Once the amount is entered, the screen shown in FIG. 6 is displayed to enable the user to enter an amount of a tip 224.

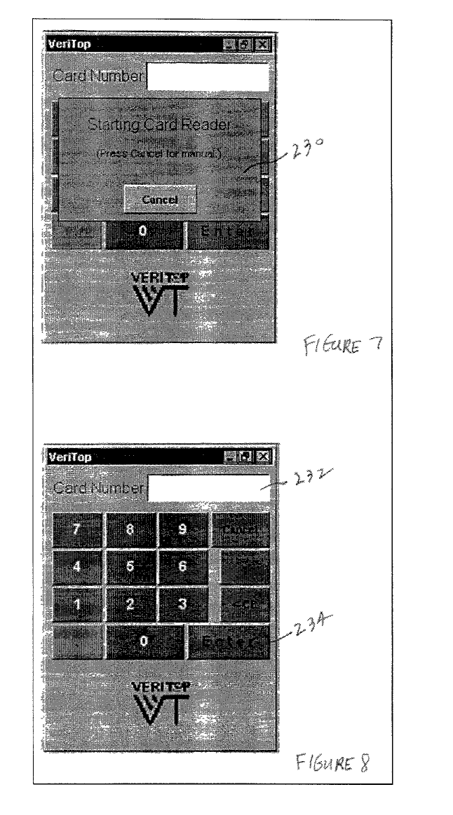

After the tip is entered, the screen shown in FIG. 7 is displayed to indicate to the user that a card stripe reader 18 (FIG. 1) is being started. If the user clicks the cancel button 230, the stripe reader is not started and the user or driver can enter the card number manually using the displayed key pad.

Otherwise, after the stripe reader has been started, the user can swipe the card 16 (FIG. 1) to have the reader read the card number and other information that may be stored on the card's stripe 20. In either case (swiping or manual entry) the card number is displayed in box 232.

When the enter button 234 is clicked, the screen shown in FIG. 9 is displayed to enable manual entry of the expiration date of the card in box 236.

The card reader and printer shown in FIG. 1 need not be part of the same device as the stripe reader and the hand-held device. Instead the card reader and printer can be mounted in a separate device or devices that communicate with the stripe reader and handheld device using IRDA infra red beams or other wireless techniques.

Of course, any kind of transaction information and any kind of financial account identifier could be entered. And the information could be entered through the touch screen (by tapping or by handwriting using a stylus 22) or the magnetic stripe reader, or could be spoken into the PDA, for example. If the credit or debit card is a smart card, the card could be read by a smart card reader.

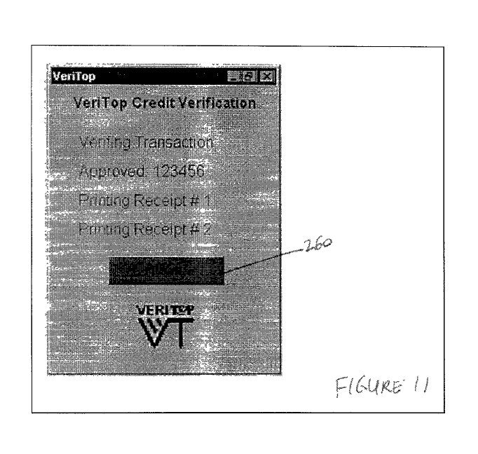

When the enter button 240 on FIG. 9 is clicked, the confirmation screen shown in FIG. 10 is displayed to provide a summary 242 of the information that will be used in the transaction. The summary includes the name of the card holder, the card number, the number of the driver, the date, the amount of the transaction, the amount of the tip, and the total amount.

The transaction can be cancelled by clicking the cancel button 242.

If the user wishes to proceed, he enters his signature by writing within box 248 and clicks the confirm button 246, thus requesting authorization (110, FIG. 2) for the transaction. An application running on the PDA would capture the handwritten signature and forward it through the network 30 to the server 32.

In response to the authorization request, the PDA either through its own wireless (infrared, RF, or other) port 24 (FIG. 1) or through a wireless port 26 that is part of the carriage 28 transfers the account identification, the transaction information, and the authorization request through a network 30 to a server 32.

At the server 32, a server authorization application 40 receives the authorization request and processes it (112) either locally in the manner that is typically used by card issuers or authorization clearinghouses, or forwards the request to a card issuer's server or clearinghouse 42 and awaits receipt of an authorization code.

The server returns the authorization code to the merchant (114). At the PDA, the screen shown in FIG. 11 is displayed, giving the authorization code and indications of the printing of two receipts. If the user does not wish to have printed receipts, the cancel button 260 can be clicked to terminate the printing.

Alternatively, the card holder's signature could be provided on a charge slip 50 that is printed by a thermal or other small printing engine 54 that is part of the hand-held device 10 (or a separate device as mentioned earlier). In that case, once the cardholder has signed the charge slip, the driver can indicate to the PDA by an appropriate action that the signature has been received and the confirmation is then reported back through the network to the server.

The second copy of the charge slip may be given to the cardholder as a record of the transaction. The second copy could contain a copy of the signature of the user, if the original signature was done directly (or through the first copy) on the screen of the PDA.

At the server, a charging application 43 takes steps to have debit and credit accounting entries made (118) in the respective financial accounts of the driver (or his employer). In the case of the cardholder, the transaction would be a charge to the holder's card account 44, which would be billed to the cardholder at the end of the usual monthly cycle. In the case of the merchant, the transaction would be a credit to the merchant's commercial account 46.

The accounts 44 and 46 need not be located in the same place and need not be under control of the same party. Instead one or more account servers 48 could handle the account transactions under control of one or more banks or other financial institutions and the accounts 50 could be located in other locations.

A variety of other services (120) can be provided to the merchant and card holder from applications running on the server or other servers prior to, as part of, or after the authorization transaction.

For example, after a transaction is completed, a user could tap a button to, e.g., access a scheduling application or a wide variety of other applications that are part of a customer relationship management approach. The other applications could relate to health care, financial functions such as stock trades, retail purchases, web portal access, and e-mail.

Server 32 and the hand-held device 10 communicate using a terminal/server mode of communication.

In the terminal/server mode of communication, the applications that control the authorization process, the charging process, and any other processes that provide related functions run almost completely on the server based on an operating system that is portable among a wide variety of platforms. The applications running on the server communicate with each of the hand-held devices through a communication application 52 running on the server, and a corresponding communication application running on the hand-held devices that are being served by the server.

The server communication application 52 sends relatively little information associated with the running application over a potentially low-bandwidth channel to the hand-held device (which may be called a very slim client). The communicated information largely includes interface information about graphical elements that are to be displayed on the screen of the hand-held devices. For example, at the time that the application running on the server is expecting a request for an authorization code, the server may instruct the PDA to display an icon that says “Request Authorization Code”.

The server communication application also receives relatively little information from the hand-held device, such as a simple indication that the user has tapped the screen at the location of the icon thus indicating that the authorization code has been requested. Essentially all of the business processing that surrounds the request for authorization code is then handled by the application running on the server. In this way each of the hand-held devices operates essentially as a terminal to the central server.

The terminal application and the server application operate in a way that synchronizes the user interface on the hand-held device to a mirrored virtual user interface running with the application on the server.

Because the amount of information that must be communicated between the terminal application and the server application is relatively small, a low-bandwidth channel can provide enough throughput and a large number of hand-held devices can be served.

The terminal application is a thin client that runs on the usual PDA operating system (such as Palm OS or Windows CE). The thin client is able to cause the hand-held device to display graphical, text, and other interface elements that are received from the server on the screen of the hand-held device, and to communicate user input in a variety of forms back to the server application.

Since no data is actually on the terminal device, no security breaches are possible should a device be stolen. In addition all communications between terminal and server are encrypted using highly secure 12-bit public key seeded encryption (Diffie-Hellman key exchange algorithm) providing users with seamless end to end security.

Because essentially all of the information that is used by the server is not stored on the hand-held device, but rather on the server, there is a high level of security provided and loss or theft of the hand-held device does not present a great risk. When the PDA is shut off, any transient data, such as credit or debit account numbers, that was temporarily stored in the RAM of the device is lost. The applications can be designed so that such numbers are discarded from the PDA as soon as each transaction is completed.

In addition, because the data is maintained centrally, it is possible to provide a wide variety of financial and related services to users of the hand-held devices, all from central locations. The services can be provided centrally in a manner that significantly reduces the cost of creating and maintaining the applications, because upgrades only require changes to a small number of easily controlled versions running on central servers. In general, there is no need to upgrade the thin-client application running on the hand-held devices.

The client and server can be implemented using any software that provides the ability to maintain open communication sessions with multiple remote devices and to run applications on the server for the benefit of the devices which act as terminals, rather than clients, to the servers. An example is the SkyFire technology available from Marbles, Inc., of North Billerica, Mass.

The mechanical and electromechanical construction for the handheld device can vary widely. The construction can be modular to permit custom assembly of a wide variety of configurations. The modules could be one or more of a docking station for the PDA, a PDA, a mobile telephone, a geographic position sensor (GPS) device, a printer, a card stripe reader, a microphone, a speaker, and an antenna, a fingerprint reader, a face recognizer, a contactless magnetic card reader, and ports for a wide range of communication protocols. Each of the components could be custom-designed or be essentially off-the-shelf versions.

The customer need not hold a credit or debit card but may simply have information about a financial account that he holds with a financial institution.

Confirmation by the user of his intention to enter into the transaction need not be by signature but could be based on other biological indicators, such as finger prints and voice prints.

Other implementations are within the scope of the following claims.

1. A method comprising
opening simultaneous communication sessions between electronic devices and a server, the communication sessions being carried on communication links each of which is at least partially wireless,
sending from the devices to the server information associated with proposed debit or credit transactions,
completing the transactions using an application running on the server,
maintaining the communications sessions in existence during inactive periods when information about another debit or credit transaction is not waiting to be sent from one or more of the devices to the server, and
after the inactive periods, using the maintained communication sessions to send, from the devices to the server, information associated with other proposed debit or credit transactions.

2. The method of claim 1 in which the electronic devices comprise off-the-shelf stand-alone hand-held devices.

3. The method of claim 1 in which at least one of the communication links uses a TCP/IP protocol.

4. The method of claim 1 in which the information about the debit or credit transactions is entered interactively through user interfaces of the devices.

5. The method of claim 1 in which the information about the transactions is discarded at each of the devices when the transactions have been completed.

6. Apparatus comprising
electronic devices configured to be capable of initiating and maintaining communication sessions with a server, the communication sessions being carried on communication paths that are at least partially wireless,
a server configured to receive information sent from the devices, using the communication sessions, about debit and credit transactions, and to maintain the sessions at times when no information about debit and credit transactions is being sent from the devices to the server.

7. A method comprising
opening a communication session between an electronic device and a server, the communication session being carried on a communication link that is at least partially wireless,
sending from the device to the server, using the communication session, information associated with a proposed debit or credit transaction,
completing the transaction using an application running on the server,
after the transaction has been completed, maintaining the communication session during an inactive period when information about another debit or credit transaction is not waiting to be sent from the device to the server,
after the inactive period, sending from the device to the server, using the communication session, information associated with another proposed debit or credit transaction, and
effecting the transaction using an application running at the server.

8. The method of claim 7 in which the electronic device comprises an off-the-shelf stand-alone hand-held device.

9. The method of claim 7 in which the communication link uses a TCP/IP protocol.

10. The method of claim 7 in which the information about the debit or credit transactions is entered interactively through a user interface of the device.

11. The method of claim 7 in which the information about the transaction is discarded at the devices when the transactions have been completed.

12. A method comprising
exchanging information with a user at an electronic device, the information being about a proposed credit or debit transaction, the information being exchanged through a user interface that includes an information display and an information input device,
communicating information that is input by a user from the electronic device to a server through a communication link that is at least partially wireless,
the display of information to the user on the information display and the receipt of information from the user through the information input device being controlled through the communication link by an application running on the server, and
at the server, using the information input by the user and communicated to the server to effect the transaction.

13. The method of claim 12 in which the electronic device comprises an off-the-shelf stand-alone hand-held device.

14. The method of claim 12 in which the communication link uses a TCP/IP protocol.

15. The method of claim 12 in which the information about the debit or credit transactions is entered interactively through a user interface of the device.

16. The method of claim 12 in which the information about the transaction is discarded at the devices when the transactions have been completed.

17. A method comprising
exchanging information with a user electronic device, the information being about a proposed credit or debit transaction, the information being exchanged through a user interface that includes an information display and an information input device, the electronic device comprising a publicly-distributed, stand-alone interactive hand-held device running a publicly available operating system,
communicating information that is input by a user from the electronic device to a server through a communication link that is at least partially wireless, and
at the server, using the information input by the user and communicated to the server to effect the transaction.

18. The method of claim 17 in which the communication link uses a TCP/IP protocol.

19. The method of claim 17 in which the information about the debit or credit transactions is entered interactively through a user interface of the device.

20. The method of claim 17 in which the information about the transaction is discarded at the devices when the transactions have been completed.

21. A method comprising
exchanging information at an electronic device, the information being about proposed credit or debit transactions of customers, the information including confidential identification information about accounts of the customers,
communicating information about the transactions, including the confidential identification information, from the device to a server over a communication link that is at least partially wireless,
effecting the transactions from the server, and
discarding the confidential identification information at the device after the transactions have been effected so that the confidential identification information is not retained on the electronic device when it is powered down.

22. The method of claim 21 in which the electronic device comprises an off-the-shelf stand-alone hand-held device.

23. The method of claim 21 in which the communication link uses a TCP/IP protocol.

24. The method of claim 21 in which the information about the debit or credit transactions is entered interactively through a user interface of the device.

25. A method comprising
exchanging information at hand-held devices, the information being about proposed credit or debit transactions,
at a server, receiving information about the transactions from the devices through communication links that are at least in part wireless,
running an application on the server, the application being configured to effect credit and debit transactions using the received information received from the hand-held devices,
effecting credit and debit transactions using the application and the received information,
updating the application on the server without updating any application related to the processing of credit and debit transactions on the devices, and
after the updating, continuing to effect credit and debit transactions using the updated application.

26. The method of claim 25 in which the electronic devices comprise off-the-shelf stand-alone hand-held devices.

27. The method of claim 25 in which the communication links use a TCP/IP protocol.

28. The method of claim 25 in which the information about the debit or credit transactions is entered interactively through a user interface of the device.

29. The method of claim 25 in which the information about the transaction is discarded at the devices when the transactions have been completed.

30. A method comprising
exchanging information at hand-held devices, the information being about proposed credit or debit transactions,
at a server, receiving information about the transactions from the devices through communication links that are at least in part wireless,
running an application on the server, the application being configured to effect credit and debit transactions using the received information received from hand-held,
effecting credit and debit transactions using the application and the received information,
running other applications at the server, the other applications not being ones that effect credit or debit transactions, and
controlling user interfaces at the hand-held devices from the server to provide functions of the other applications to users of the hand-held devices at times when information about credit or debit transactions is not being exchanged.

31. Apparatus comprising
an interactive handheld device,
a reader for reading debit or credit cards to be used in debit or credit transactions entered on the hand-held device, and
a printer adapted to print receipts for debit or credit transactions,
the device, the reader, and the printer having short-range wireless communication capability to carry information about the credit or debit transactions between the device and the reader and between the device and the printer.

32. A method comprising
running a client application on a mobile electronic device and a server application on a central server, the server application controlling the client application to provide financial transaction authorization services with respect to transactions occurring at the mobile electronic device, and
providing additional non-financial transaction services by additional client applications at the mobile electronic device, the additional client applications being under the control of additional server applications running on the server.

33. A method comprising
entering information about credit or debit transactions at hand-held devices using interfaces that are under control of an application running at a remote server, the devices acting as terminals to the server,
communicating the information using continually maintained communication sessions carried on communication links that re at least partly wireless,
effecting the transactions using applications running at the server, and
discarding information about credit or debit accounts at each device when the communication session is ended.
